(19) United States
(12) Patent Application Publication
(10) Pub. No.: US 2011/0255312 A1
(43) Pub. Date: Oct. 20, 2011

(54) POWER CONVERTER WITH PRIMARY-SIDE FEEDBACK CONTROL

(76) Inventors: Chin-Yen Lin, Hsinchu County (TW); Min-Chu Chien, Hsinchu County (TW)

(21) Appl. No.: 12/883,195

(22) Filed: Sep. 16, 2010

Related U.S. Application Data
(60) Provisional application No. 61/324,748, filed on Apr. 16, 2010.

(51) Int. Cl. H02M 3/335

(52) U.S. Cl. 363/21.16

(57) ABSTRACT

A power converter with primary-side feedback control includes a transformer comprising a primary winding, an auxiliary winding, and a secondary winding, for transforming an input voltage into an output voltage; a transistor coupled to the primary winding for controlling electric energy transforming of the transformer according to a first control signal; a control unit coupled to the transistor for generating the first control signal according to a feedback signal in order to control the transistor to be turned on or off; and a peak detection unit coupled between the auxiliary winding and the control unit for generating the feedback signal according to a knee voltage of a first voltage signal.

### CROSS REFERENCE TO RELATED APPLICATIONS

This application claims the benefit of U.S. Provisional Application No. 61/324,748, field on Apr. 16, 2010 and entitled “PRIMARY-SIDE CONTROL POWER CONVERTER” the contents of which are incorporated herein in their entirety.

### BACKGROUND OF THE INVENTION

1. Field of the Invention

The present invention relates to a power converter, and more particularly to a power converter for performing primary-side feedback control according to a knee voltage of a voltage signal on an auxiliary winding of the power converter.

2. Description of the Prior Art

A switching power converter is used to convert high AC power or DC power into low DC power and is widely used for a power supply in electronic equipments. A power converter in a switching power supply can be of different types, e.g. a flyback converter, a forward converter, and a push-pull converter. Please refer to FIG. 1, which illustrates a schematic diagram of a power converter 10. The power converter 10 is a flyback converter and includes a transformer 100, a transistor 102, a pulse width modulation (PWM) control unit 104, a feedback control unit 106, a rectifier 108 (e.g. a diode) and a capacitor C1. The transformer 100 includes a primary winding NP and a secondary winding NS. The feedback control unit 106 includes the resistors R1-R4, a capacitor C2, an optocoupler 110 and a three-terminal shunt regulator 112.

The power converting function of the power converter 10 is realized via the pulse width modulation control unit 104 by controlling the transistor 102. The pulse width modulation control unit 104 generates a corresponding control signal V_{PWM} to control the transistor 102 to be turned on or cut off according to a feedback signal V_{F}. When the transistor 102 is turned on, the electrical power is stored within the primary winding NP and the rectifier 108 is cut off due to the inverse bias voltage and the electrical power that the load of the power converter 10 requires is provided by the capacitor C1. When the transistor 102 is cut off, the electrical power stored within the primary winding NP transfers to the secondary winding NS, the rectifier 108 is turned on and the electrical power transfers to the load. The power converter 10 uses the structure of secondary-side feedback control, and the feedback signal V_{F} is generated by the optocoupler 110 driven by the three-terminal shunt regulator 112. When an output voltage V_{OUT} of the power converter 10 increases or decreases, the feedback signal V_{F} changes with the output voltage V_{OUT} and thereby changes the duty cycle of the control signal V_{PWM} for adjusting the electrical power outputted to the load to keep the output voltage V_{OUT} stable. The three-terminal shunt regulator 112 needs peripherals including resistors R1, R2, R3 and a capacitor C2 to complete the function. The resistors R1 and R2 are used for dividing voltage of the output voltage V_{OUT} to generate the reference voltage of the three-terminal shunt regulator 112. The resistor R3 and the capacitor C2 are used for providing the loop compensation needed by the three-terminal shunt regulator 112.

Except the structure of secondary-side feedback control, the power converter also can use the structure of primary-side feedback control. The transformer of the power converter with primary-side feedback control not only has a primary winding and a secondary winding, but also has an auxiliary winding without an optocoupler and the three-terminal shunt regulator. When current passes through the secondary winding, the auxiliary winding can induce the variation of the output voltage of the power converter. Thus, the pulse width modulation control unit of the power converter can generate the feedback signal according the voltage signal on the auxiliary winding and thereby generate the control signal to control the duty cycle of the transistor for adjusting the electrical power outputted to the load. Compared to the optocoupler and the three-terminal shunt regulator with high production cost and larger circuit area, primary-side feedback control can reduce the cost of the power converter efficiently.

The prior art provides many kinds of practices of the power converter with primary-side feedback control, such as U.S. Pat. No. 6,956,750, which discloses a power converter with primary-side feedback control including an event detection module for detecting a knee voltage (i.e. the voltage on the auxiliary windings when current passing through the secondary winding decreases to zero) and detecting the error difference between the knee voltage and a reference voltage for adjusting the electrical power outputted to the load according to the error difference. Further, U.S. Pat. No. 7,259,972 discloses a power converter with primary-side feedback control including a controller for generating a control signal to adjust the electrical power outputted to the load according to two feedback signals. The important goal of the power converter design is to use the simplest circuit to achieve the feedback control function in the power converter.

### SUMMARY OF THE INVENTION

It is therefore an objective of the present invention to provide a power converter with primary-side feedback control.

A power converter with primary-side feedback control is disclosed. The power converter includes a transformer comprising a primary winding, an auxiliary winding, and a secondary winding, for transforming an input voltage into an output voltage; a transistor coupled to the primary winding for controlling electric energy transforming of the transformer according to a first control signal; a control unit coupled to the transistor for generating the first control signal according to a feedback signal in order to control the transistor to be turned on or off; and a peak detection unit coupled between the auxiliary winding and the control unit for generating the feedback signal according to a knee voltage of a first voltage signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power converter according to the prior art.

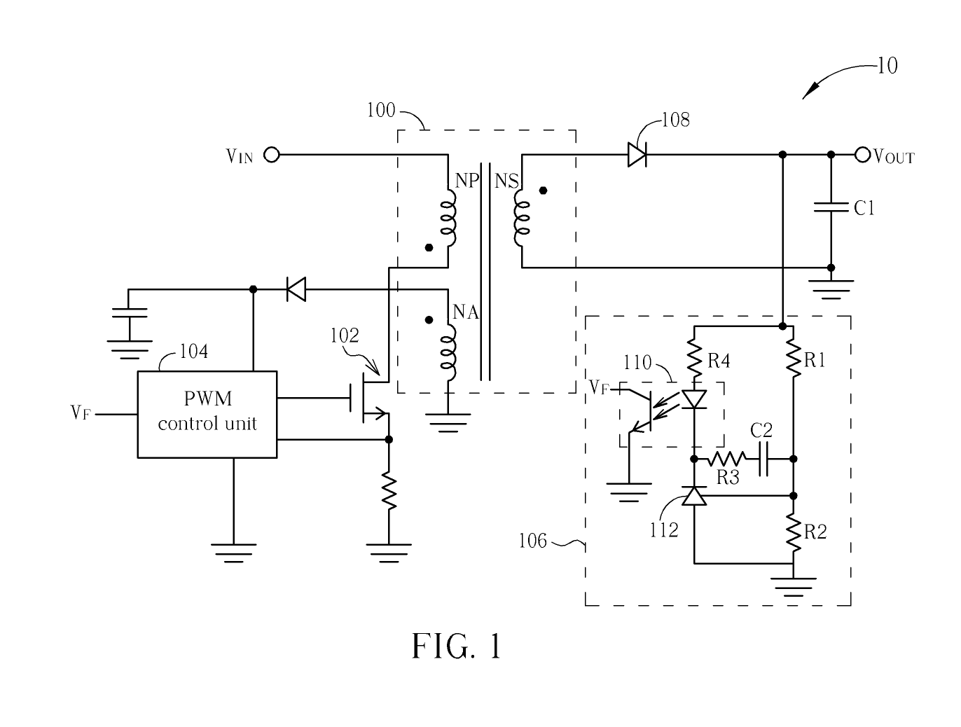

FIG. 2 is a schematic diagram of a power converter according to an embodiment of the present invention.

FIG. 3 is a time sequence diagram of related signals of a power converter shown in FIG. 2.

FIG. 4 is a schematic diagram of a power converter shown in FIG. 2.

### DETAILED DESCRIPTION

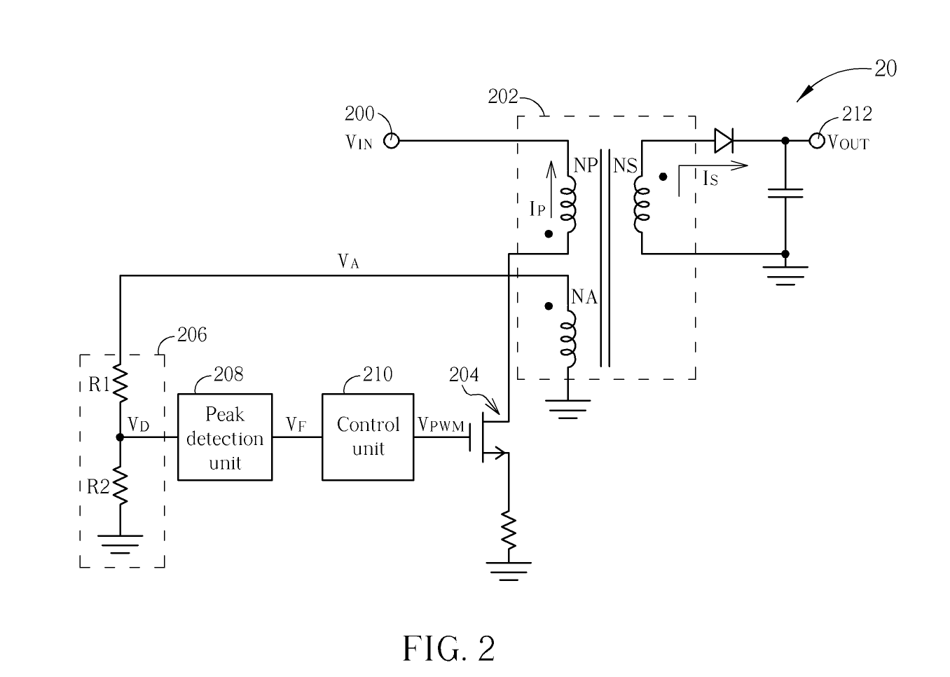

Please refer to FIG. 2, which illustrates a schematic diagram of a power converter 20 according to an embodiment of the present invention. The power converter 20 includes an input terminal 200, a transformer 202, a transistor 204, a voltage dividing unit 206, a peak detection unit 208, a control unit 210 and an output terminal 212. The structure of feedback control of the power converter 20 is the structure of primary-side feedback control. Please note that other components for practicing the power converter, for example a rectifier in the secondary side of the transformer 202 and other passive components, etc. are well-known for those skilled in the art, and only shown in FIG. 2 and are not described below. The transformer 202 includes a primary winding NP coupled to the input terminal 200 and the transistor 204, a secondary winding NS coupled to the output terminal 212 and an auxiliary winding NA coupled to the voltage dividing unit 206. The transformer 202 is used for transforming an input voltage V_{IN} received from the input terminal 200 into an output voltage V_{OUT} outputted to the load via the output terminal 212. Current passing through the primary winding NP is denoted as I_{P}, current passing through the secondary winding NS is denoted as I_{S}, and a voltage signal on the auxiliary winding NA is denoted as V_{A}.

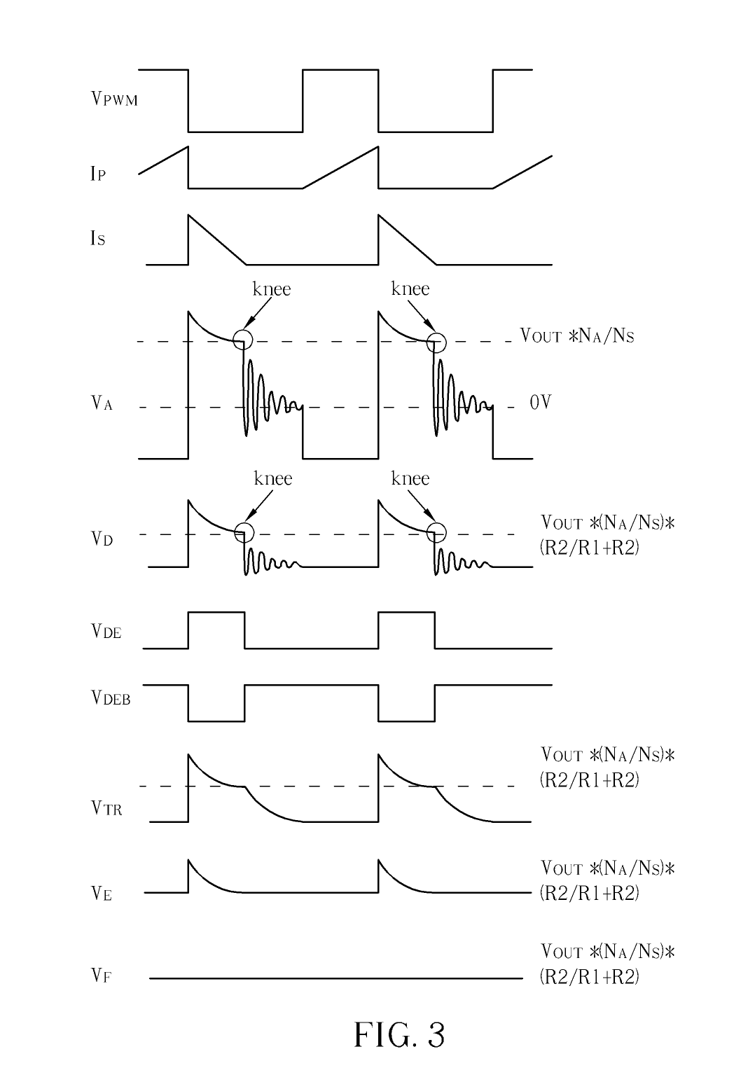

The transistor 204 is coupled to the primary winding NP and the control unit 210. The on and off statuses of the transistor 204 are controlled by a control signal V_{PWM} generated by the control unit 210. The control signal V_{PWM} is a pulse width modulation (PWM) signal. Please refer to FIG. 3, which illustrates a time sequence diagram of related signals of the power converter 20 shown in FIG. 2, including the control signal V_{PWM}, the current I_{P}, the current I_{S} and the voltage signal V_{A}. When the control signal V_{PWM} transforms from a low voltage level to a high voltage level, the transistor 204 is turned on, the current I_{P} passing through the primary winding NP increases and the electrical power generated by the input voltage V_{IN} is stored in the primary winding NP, the rectifier of the secondary-side is cut off due to the inverse bias voltage and the current I_{S} passing through the secondary winding NS is zero. When the control signal V_{PWM} transforms from a high voltage level into a low voltage level, the transistor 204 is cut off and the current I_{P} passing through the primary winding NP decreases to zero, the electrical power stored in the primary winding NP is transferred to the secondary winding NS and thus the current I_{S} passing through the secondary winding NS increases.

When current passes through the secondary winding, the output voltage V_{OUT} is induced in the auxiliary winding NA. As shown in FIG. 3, when the transistor 204 stays in the off status (i.e. during the low voltage level of the control signal V_{PWM}), the electrical power transferred to the secondary-side consumes to zero and the current I_{S} decreases to zero, the voltage signal V_{A} on the auxiliary winding NA decreases rapidly from the high voltage level and the voltage on the transition place is called the knee voltage. Assuming that the bias voltage of the rectifier on the secondary-side is ignored, the relationship between the knee voltage of the voltage signal V_{A} on the auxiliary winding NA and the output voltage V_{OUT} is V_{A}=V_{OUT}×N_{A}/N_{S}, where N_{A} and N_{S} are the number of coils of the auxiliary winding NA and the secondary winding NS respectively. An ideal voltage level of the output voltage V_{OUT} is a fixed value, however, when the output voltage V_{OUT} varies with the change of the load, the voltage signal V_{A} on the auxiliary winding NA and the knee voltage of the voltage signal V_{A} vary accordingly.

Please note that the characteristic of the power converter 20 is that the peak detection unit 208 generates a feedback signal V_{F} according to the knee voltage of the voltage signal V_{A} and the control unit 210 generates the corresponding control signal V_{PWM} according to the feedback signal V_{F}. The control signal V_{PWM} controls the transistor 204 to be turned on or cut off by an appropriate duty cycle for adjusting the electrical power transferred from the primary side to the secondary side of the transformer 202 to supply the stable output voltage V_{OUT} to different loads. When the output voltage V_{OUT} of the power converter 20 is at a high voltage level, e.g. more than 10 Volt, the knee voltage of the voltage signal V_{A} is also high and may not be used for the inner circuit of the peak detection unit 208. As shown in FIG. 2, the peak detection unit 208 is not coupled to the auxiliary winding NA for detecting the knee voltage of the voltage signal V_{A} directly and is coupled to the voltage dividing unit 206 for detecting the knee voltage of a voltage signal V_{D} outputted from the voltage dividing unit 206. The voltage signal V_{D} is generated by the voltage dividing unit 206 which divides the voltage of the voltage signal V_{A}. The voltage dividing unit 206 includes resistors R1 and R2. The resistor R1 has one terminal coupled to the auxiliary winding NA and another terminal coupled to the resistor R2. The resistor R2 has one terminal coupled to the resistor R2 and another terminal coupled to the grounding terminal.

Please refer to FIG. 3. When the current I_{S} passing through the secondary winding decreases to zero, the voltage signal V_{A} on the auxiliary winding NA decreases from the knee voltage. Accordingly, the voltage signal V_{D} generated by the voltage dividing unit 206 also decreases from the knee voltage. At this time, the relationship of the voltage signals V_{D} and V_{A} is V_{D}=V_{A}×R2/(R1+R2)=V_{OUT}×N_{A}/N_{S}×R2/(R1+R2). From the above, the knee voltage of the voltage signal V_{D} varies with the output voltage V_{OUT}, thus, the peak detection unit 208 can detect the voltage signal V_{D} instead of detecting the voltage signal V_{A} directly, to get the variation of the output voltage V_{OUT}.

The voltage dividing unit 206 shown in FIG. 2 is an embodiment of the present invention and can be combined with other components to generate a signal of a lower voltage level corresponding to the voltage signal V_{A} in other embodiments of the present invention. For example, the resistor R2 paralleled with a diode and capacitors brings help to the peak detection unit 208 to generate a more stable feedback signal V_{F}. In addition, when the output voltage V_{OUT} is at a low voltage level, the voltage dividing unit 206 can be omitted and the peak detection unit 208 is coupled directly to the auxiliary winding NA to detect the knee voltage of the voltage signal V_{A} on the auxiliary winding NA.

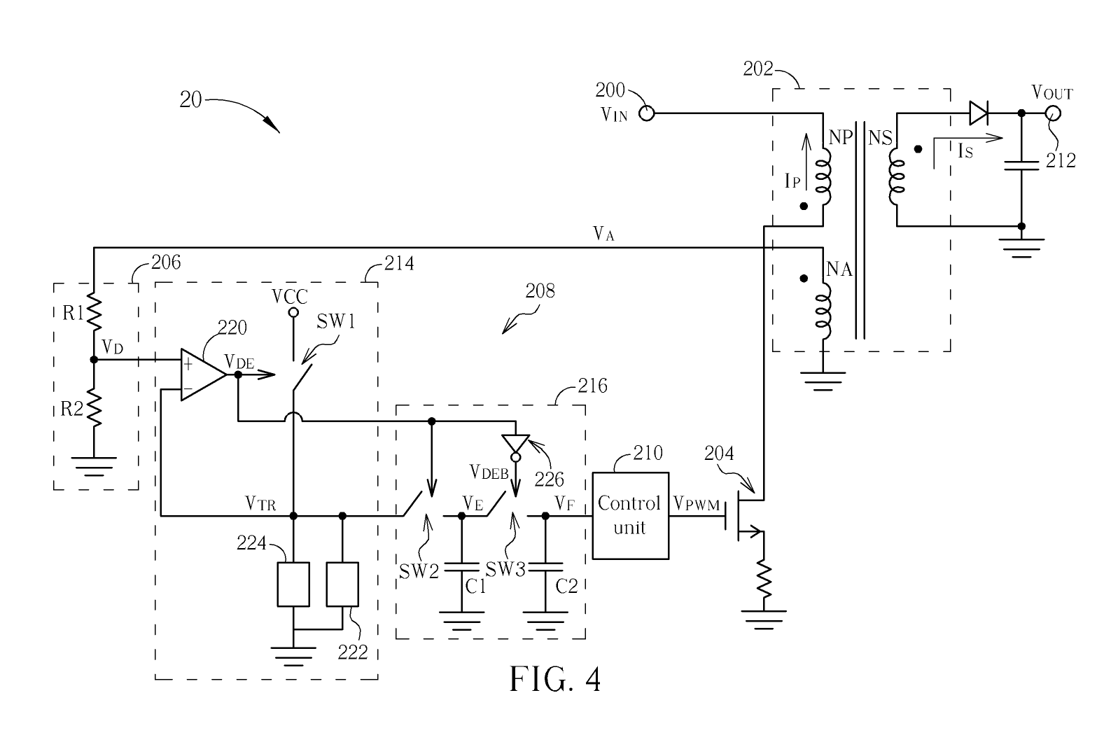

Please refer to FIG. 4, which is a schematic diagram of the power converter 20 for illustrating the peak detection unit 208 in details. The peak detection unit 208 includes a voltage tracking unit 214 and a sample-and-hold unit 216. The voltage tracking unit 214 includes an operational amplifier 220, a switch SW1, a voltage storage unit 222 and a discharging unit 224. The positive input terminal of the operational amplifier 220 is coupled to the voltage dividing unit 206 for receiving the voltage signal V_{D} outputted by the voltage dividing unit 206; the negative input terminal of the operational amplifier 220 is coupled to the switch SW1, the voltage storage unit 222, the discharging unit 224 and the sample-and-hold unit 216, and the signal of the negative input terminal of the operational amplifier 220 is a voltage signal V_{TR}; the output terminal of the operational amplifier 220 is coupled to the switch SW1 and the sample-and-hold unit 216 for outputting a control signal V_{DE} to control the switch SW1 to be turned on or cut off and the control signal V_{DE} is outputted to the sample-and-hold unit 216. The switch SW1 is a three-terminal switch having a first terminal coupled to the output terminal of the operational amplifier 220, a second terminal coupled to a voltage VCC, a third terminal coupled to the negative input terminal of the operational amplifier 220 and the voltage storage unit 222 parallel with the discharging unit 224. For example, the switch SW1 can be an n-type MOSFET having a gate as the first terminal of the switch SW1, a drain and a source as the second terminal and the third terminal of the switch SW1 respectively. The voltage storage unit 222 can be a capacitor simply and the discharging unit 224 can be a resistor.

About the operation of the voltage tracking unit 214, please refer to related signals shown in FIG. 3. When current passes through the secondary winding NS (i.e. the time when the current I_{S} larger than zero) and the voltage signal V_{D} varies with the voltage signal V_{A} on the auxiliary winding NA, the voltage level of the voltage signal V_{D} is a little higher than that of the voltage signal V_{TR} and the control signal V_{DE} outputted by the operational amplifier 220 controls the switch SW1 to be turned on to make the voltage signal V_{TR} approximate to the voltage signal V_{D}. The discharging unit 224 is a discharging path. When the switch SW1 is turned on and the voltage VCC charges the voltage storage unit 222, the discharging unit 224 discharges the voltage storage unit 222, and therefore the voltage level of the voltage signal V_{TR} is a little lower than that of the voltage signal V_{D}.

When the current I_{S} passing through the secondary winding NS decreases to zero, the voltage signal V_{D} of the positive input terminal of the operational amplifier 220 decreases rapidly from the knee voltage and thus the voltage difference between the voltage signal V_{D} and the voltage signal V_{TR} increases rapidly to cut off the switch SW1. At this time, the voltage VCC stops charging the voltage storage unit 222, and discharging unit 224 discharges the voltage storage unit 222. As shown in FIG. 3, after the time that the knee voltage of the voltage signal V_{D} occurs, the voltage signal V_{TR} varies as a discharging curve. From the waveform of the voltage signals V_{D} and V_{TR} shown in FIG. 3, when the current I_{S} decreases to zero, the knee voltage of the voltage signal V_{D} occurs, and the knee voltage of the voltage signal V_{TR} also occurs. At this time, the relationship of the voltage signals V_{D} and V_{TR} is V_{TR}=V_{D}=V_{OUT}×N_{A}/N_{S}×R2/(R1+R2).

The sample-and-hold unit 216 includes an inverter 226, switches SW2 and SW3, and capacitors C1 and C2 for sampling the knee voltage of the voltage signal V_{TR} to generate the feedback signal V_{F} outputted to the control unit 210. The inverter 226 is coupled to the output terminal of the operational amplifier 220 and is used for generating a control signal V_{DEB} by inversing the control signal V_{DE}. The switch SW2 has one terminal coupled to the negative input terminal of the operational amplifier 220 and another terminal coupled to the capacitor C, and is turned on or cut off by the control signal V_{DE}. The switch SW3 has one terminal coupled to the capacitor C1 and another terminal coupled to the capacitor C2, and is turned on or cut off by the control signal V_{DEB}. The capacitor C1 has one terminal coupled to the switch SW2 and the switch SW3 and the voltage signal of the terminal is denoted as V_{E}. The capacitor C1 has another terminal coupled to the grounding terminal. The capacitor C2 has one terminal coupled to the switch SW3 and the control unit 210 and the voltage signal of the terminal is the feedback signal V_{F} generated by the peak detection unit 208. The capacitor C2 has another terminal coupled to the grounding terminal.

The operation of the sample-and-hold unit 216 is described below. When current passing through the secondary winding NS, the control signal V_{DE} outputted by the operational amplifier 220 is at a high voltage level and the control signal V_{DEB} is at a low voltage level, the switch SW2 is turned on and the switch SW3 is cut off, and the voltage signal V_{TR} is recorded by capacitor C1. As shown in FIG. 3, when the control signal V_{DE} is at the high voltage level, the voltage signal V_{E} and the voltage signal V_{TR} are the same. When the current I_{S} passing through the secondary winding NS decreases to zero, the control signal V_{DE} transforms from the high voltage level into the low voltage level and the control signal V_{DEB} transforms from the low voltage level into the high voltage level, and the switch SW2 is cut off and the switch SW3 is turned on, so that the voltage signal V_{E} is transferred to the capacitor C2 to be the voltage signal on the capacitor C2 as the feedback signal V_{F}. Note that when the knee voltage of the voltage signal V_{TR} occurs, the capacitor C1 stops recording the voltage signal V_{TR}. At this time, the voltage level of the voltage signal V_{E} equals the knee voltage of the voltage signal V_{TR} and the relationship of the feedback signal V_{F} and the voltage signal V_{TR} is V_{F}=V_{TR}=V_{OUT}×N_{A}/N_{S}×R2/(R1+R2).

In short, when current passing through the secondary winding NS decreases to zero, the knee voltage of the voltage signal V_{A} and the voltage signal V_{D} occur and the knee voltage of the voltage signal V_{TR} generated by the voltage tracking unit 214 occurs accordingly. The sample-and-hold unit 216 samples the knee voltage of the voltage signal V_{TR} for generating the feedback signal V_{F}, and thereby the control unit 210 can generate the control signal V_{PWM} for controlling the transistor 204 to be turned on or cut off, to control the electrical power transformation of the transformer 202. Therefore, when the load of the power converter 20 changes and causes the change of the output voltage V_{OUT}, the knee voltage of the voltage signal V_{D} changes accordingly, the peak detection unit 208 generates the feedback signal V_{F} corresponding to the knee voltage of the voltage signal V_{A} and thereby the control unit 210 generates the control signal V_{PWM} with appropriate duty cycle according to the feedback signal V_{F}. The control signal V_{PWM} is used for controlling the transistor 204 for adjusting the electrical power transferred to the second-side to supply different loads.

In conclusion, the power converter of the present invention uses a peak detection unit with the simple structure for detecting the knee voltage of the voltage signal on the auxiliary winding and thereby generating the feedback signal. Compared to the expensive power converter with secondary-side feedback control in the prior art or the power converter with primary-side feedback control with complicate structure, the power converter according to the embodiment of the present invention has the advantage of lower cost for the product application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power converter with primary-side feedback control comprising:
a transformer comprising a primary winding, an auxiliary winding, and a secondary winding, for transforming an input voltage into an output voltage;
a transistor coupled to the primary winding for controlling electric energy transforming of the transformer according to a first control signal;
a control unit coupled to the transistor for generating the first control signal according to a feedback signal in order to control the transistor to be turned on or off; and
a peak detection unit coupled between the auxiliary winding and the control unit for generating the feedback signal according to a knee voltage of a first voltage signal.

2. The power converter of claim 1, wherein the first voltage signal is a voltage signal on the auxiliary winding.

3. The power converter of claim 1 further comprising a voltage dividing unit coupled to the auxiliary winding and the peak detection unit, for dividing a voltage signal on the auxiliary winding to generate the first voltage signal.

4. The power converter of claim 1, wherein the feedback signal equals the knee voltage of the first voltage signal.

5. The power converter of claim 1, wherein the peak detection unit comprises:
a voltage tracking unit for tracking the first voltage signal to output a second voltage signal and outputting a second control signal; and
a sample-and-hold unit coupled to the voltage tracking unit and the control unit for sampling the second voltage signal to generate the feedback signal.

6. The power converter of claim 5, wherein the voltage tracking unit comprises:
an operational amplifier comprising a positive input terminal coupled to the auxiliary winding, a negative input terminal and an output terminal coupled to the sample-and-hold unit for outputting the second control signal to the sample-and-hold unit;
a voltage storage unit having one terminal coupled to the negative input terminal of the operational amplifier and another terminal coupled to a grounding terminal;
a discharging unit having one terminal coupled to the negative input terminal of the operational amplifier and another terminal coupled to the grounding terminal; and
a switch coupled to the output terminal of the operational amplifier, the negative input terminal of the operational amplifier and a voltage source and controlled to be turned on and off by the second control signal.

7. The power converter of claim 6, wherein the voltage source charges the voltage storage unit and the discharging unit discharges the voltage storage unit when the switch is turned on.

8. The power converter of claim 6, wherein the discharging unit discharges the voltage storage unit when the switch is turned off.

9. The power converter of claim 6, wherein the voltage storage unit is a capacitor.

10. The power converter of claim 6, wherein the discharging unit is a resistor.

11. The power converter of claim 5, wherein the sample-and-hold unit comprises:
a first switch coupled to the voltage tracking unit and controlled by the second control signal;
a second switch coupled to the first switch and the control unit and controlled by a third control signal to make the second switch and the first switch be turned on at different time;
a first capacitor having one terminal coupled to the first switch and the second switch and another terminal coupled to a grounding terminal; and
a second capacitor having one terminal coupled to the second switch and the control unit and another terminal coupled to the grounding terminal.

12. The power converter of claim 11, wherein the sample-and-hold unit further comprises an inverter coupled to the voltage tracking unit and the second switch, for inverting the second control signal to generate the third control signal.

13. The power converter of claim 11, wherein the first capacitor records the second voltage signal outputted by the voltage tracking unit during the first switch is turned on and the second switch is turned off.

14. The power converter of claim 11, wherein the voltage of the voltage signal on the first capacitor is kept the same as the knee voltage of the second voltage signal and the second capacitor records the voltage signal on the first capacitor for being the feedback signal when the first switch is turned off and the second switch is turned on.
